(19) United States
(12) Patent Application Publication
(10) Pub. No.: US 2012/0088050 A1
(43) Pub. Date: Apr. 12, 2012

(54) REINFORCED FLAME RETARDANT FILM FOR BLAST RESISTANCE PROTECTION

(75) Inventor: Adalbert E. Lavature, Huntington, MA (US)

(73) Assignee: BERRY PLASTICS CORPORATION, Evansville, IN (US)

(21) Appl. No.: 13/274,837

(22) Filed: Oct. 17, 2011

Related U.S. Application Data
(63) Continuation-in-part of application No. 12/015,384, filed on Jan. 16, 2008, now Pat. No. 8,039,102.
(60) Provisional application No. 60/880,554, filed on Jan. 16, 2007.

(30) Foreign Application Priority Data
Jan. 16, 2008 (US) PCT/US08/51207

(51) Int. Cl. B32B 27/06; B32B 33/00; B32B 7/12; C09J 7/02; B32B 27/12

(52) U.S. Cl. 428/41.1; 428/41.8; 428/40.9; 428/41.4; 428/339; 428/41.7

(57) ABSTRACT

A flame retardant blast resistant reinforcement film for application to a structural wall or ceiling, the film comprising at least one flame retardant layer, at least one polymeric material layer, at least one energy absorptive or dissipative material layer, and an adhesive layer. The film has a puncture resistance of 3,000-25,000 psi.

### CROSS-REFERENCE TO RELATED APPLICATIONS

This application is a continuation-in-part of U.S. application Ser. No. 12/015,384, filed Jan. 16, 2008, entitled “Reinforced Film for Blast Resistance Protection;” and claims priority to PCT Application No. PCT/US08/51207 entitled “Reinforced Film for Blast Resistance Protection and Methods Thereof;” and United States Provisional Patent Application Ser. No. 60/880,554, filed Jan. 16, 2007, entitled “Reinforced Film for Blast Resistance Protection,” the disclosures of which are incorporated herein by reference in their entirety.

### FIELD

The present disclosure relates to reinforced films and laminates having high puncture resistance and fire retardance properties and which may be used to strengthen walls to greater withstand blast force impact.

### BACKGROUND

Houses and buildings located in war zones can be at risk of damage or destruction by enemy attacks or by natural disasters. Shrapnel and other flying debris from bomb blast force can wreak havoc inside a structure, particularly from wall structural material being blown apart and becoming projectiles.

Conventional systems for mitigating the results of a blast force on structures include, for example, the use of concrete barricades which have been designed and used to protect military buildings. However, such barriers are heavy, difficult to transport, expensive, and easily visible to enemy forces. Concrete barricades may also be an impractical solution in situations where the structure requiring protection is in an active war location or in a primitive third-world region. Thus, explosion blast barriers have been designed and used to protect the interior side of exterior building walls to provide increased wall integrity in the event of an explosion. In most blast barrier designs, the barriers are composed of materials that are excessively heavy, cumbersome and expensive, and simply are not practical for quick transport and deployment to a target structure. Excessive weight and decreased mobility is often the result of the barrier being too massive.

Even more recent improvements over such conventional barriers also have many weaknesses. For example, some blast barriers are sprayed onto the surface to be protected. Although this solution may be practical in some situations for new building construction, application of such a barrier is not practical in many applications, in particular, in war zones and remote regions. For example, the process of coating the walls of a single room with a heavy coating of urea most commonly used as spray for truck liners may take up to a week to accomplish, requires cumbersome equipment, and may not provide an instant protective barrier.

In addition to improved blast force resistance, it would be desire for such materials to be flame retardant since the consequences of a bomb blast may be concomitant fire, such as from a gas line rupture and ignition.

Thus, a need exists for a reinforced film that provides the necessary additional structural integrity to a structure while remaining flexible, lightweight, and easy to apply.

### SUMMARY

One aspect of the present disclosures provides a reinforced flame retardant film material, comprising a first layer of an elastomeric polymer material; a second layer of an elastomeric polymer material; an adhesive layer comprising a pressure sensitive adhesive; a layer of an energy absorptive or dissipative material; a release liner associated with the adhesive layer; and, a layer of a flame retardant material, wherein the reinforced fire retardant film material is arranged in the order of the fire retardant layer, the first layer, the energy absorptive or dissipative layer, the second layer, and the adhesive layer, and, wherein the reinforced fire retardant film material has a puncture resistance in a range between about 3,000 psi and about 25,000 psi.

Another aspect of the present disclosures provides a flame retardant reinforcement film, comprising a layer of a flame retardant material, a layer of a polymeric material, a layer of an energy absorptive or dissipative material, a layer of an adhesive material, and a removable release liner, wherein the film is arranged in the order of the flame retardant material layer, the energy absorptive or dissipative material layer, the polymeric material layer, the adhesive material layer, and the removable release liner, wherein the film wherein has a puncture resistance after the removable release liner is removed to expose the adhesive layer of between 3,000 psi and 25,000 psi as determined according to ASTM D-1000 (with a 0.166 inch needle), wherein the flame retardant layer material has a thickness in a range of 0.285 to 10 mil and the reinforced flame retardant film is flame retardant for at least 30 second to 5 minutes (depending on the foil thickness) according to the BMS-7230—Method F5 45 degree burn test method (formerly known as ASTM F1103-93) (and increased flame contact times) and wherein the reinforced flame retardant film is configured to be rolls.

Another aspect of the present disclosures provides a multi-layer flame retardant film, comprising, at least one layer of a energy absorptive or dissipative material having a first side and a second side and comprising a plurality of either fiber bundles, fiber strands or a mixture of fiber bundles and fiber strands, the fibers being between about 1,000 to about 10,000 denier, the energy absorptive or dissipative material having a plurality of openings between the fiber bundles or strands; at least one layer of an elastomeric material associated with each side of the energy absorptive or dissipative layer material, each elastomeric material layer having a thickness of between about 2 mils and about 75 mils; a layer of a pressure sensitive adhesive material; and a layer of a flame retardant material, wherein the multi-layer flame retardant film has a puncture resistance of between 3,000 psi and 25,000 psi as determined according to ASTM D-1000 (with a 0.166 inch needle), and is configured as a roll, and wherein at least a portion of the elastomeric layer material on each side of and in contact with the energy absorptive or dissipative layer material are bonded to each other with the adhesive material through at least a portion of the openings in the energy absorptive or dissipative material.

Another aspect of the present disclosures provides a structural wall or ceiling panel, comprising a wall or ceiling panel material; and, a reinforced film associated with the wall or ceiling panel material, the reinforced film comprising, a first layer of an elastomeric polymer material, a second layer of an elastomeric polymer material, an adhesive layer comprising a pressure sensitive adhesive, a layer of a energy absorptive or dissipative material, and a layer of a flame retardant material, wherein the reinforced film is arranged in the order of the flame retardant layer, the first layer, the energy absorptive or dissipative layer, the second layer, and the adhesive layer, wherein the reinforced film has a puncture resistance in a range between about 3,000 psi and about 25,000 psi, and, wherein the flame retardant layer has a thickness in a range of 0.285 to 10 mil and the reinforced flame retardant film is flame retardant film is flame retardant for at least 30 second to 5 minutes (depending on the foil thickness) according to the BMS-7230—Method F5 45 degree burn test method (formerly known as ASTM F1103-93) (and increased flame contact times).

### BRIEF DESCRIPTION OF THE DRAWINGS

The drawings disclose exemplary embodiments in which like reference characters designate the same or similar parts throughout the figures of which:

FIG. 1 depicts a cross-section of a reinforced film in accordance with an embodiment of the present disclosure;

FIG. 2 depicts a schematic of the energy absorptive or dissipative material according with one embodiment of the present disclosure;

FIG. 3 depicts an exemplary clamp for use in fastening the reinforced film to a surface, in accordance with one embodiment of the present disclosure;

FIG. 4 depicts one exemplary embodiment of a reinforced film used during experimental puncture resistance testing in accordance with embodiments of the present disclosure;

FIG. 5A is a schematic view of a first exemplary layer construction of a reinforced flame retardant film material according to the present disclosure in which the polyurethane film is cast directly on the foil;

FIG. 5B is a schematic view of a second exemplary layer construction of a reinforced flame retardant film material according to the present disclosure in which the aluminum foil is adhesive coated and laminated to the polyurethane;

FIG. 5C is a schematic view of a third exemplary layer construction of a reinforced flame retardant film material according to the present disclosure in which the aluminum foil is laminated to a flame retardant insulating layer like but not excluded to glass cloth and then adhesive coated and laminated to the polyurethane;

FIG. 5D is a schematic view of a fourth exemplary layer construction of a reinforced flame retardant film material according to the present disclosure in which the insulated layer is laminated to an adhesive coated aluminum foil then a second adhesive is coated on the insulated side of the laminate and laminated to the polyurethane;

FIG. 6A is a chart of flammability test labeled Report No. 1;

FIG. 6B is a photograph of burn test results in Report No. 1 of FIG. 6A of 0.285 mil aluminum foil side which passed after a 30 second flame contact time to the foil side;

FIG. 6C is a photograph of burn test results in Report No. 1 of FIG. 6A of polyurethane side without a PSA coating present and a 30 second flame contact time to the exposed 0.285 mil foil side;

FIG. 6D is a photograph of burn test results in Report No. 1 of FIG. 6A of a failed 60 second flame contact time aluminum foil side of the 0.285 mil foil;

FIG. 6E is a photograph of burn test results in Report No. 1 of FIG. 6A of a failed 60 second flame contact time to the 0.285 mil foil side showing the melted and burned polyurethane;

FIG. 6F is a photograph of burn test results in Report No. 1 of FIG. 6A of a failed 60 second contact time to the exposed 0.285 mil foil side showing the molten flow of the burnt polyurethane;

FIG. 7A is a chart of flammability test labeled Report No. 2;

FIG. 7B is a photograph of burn test results in Report No. 2 of FIG. 7A after contact of the flame at 1550° F. to the 1 mil exposed foil side of the laminate for 60 seconds;

FIG. 7C is a photograph of burn test results in Report No. 2 of FIG. 7A after contact of the flame at 1550° F. for 60 seconds to the exposed 1 mil foil side showing little damage to the polyurethane or the top coating of adhesive on the polyurethane side;

FIG. 7D is a photograph of 90 second burn test results in Report No. 2 of FIG. 7A showing the burn test in progress to the exposed foil side;

FIG. 7E is a photograph of 90 second burn test results in Report No. 2 of FIG. 7A showing pinpoint burn through to the 1 mil foil;

FIG. 7F is a photograph of burn test results in Report No. 2 of FIG. 7A showing burn through on the polyurethane on the opposite side of the exposed 1 mil foil the adhesive also shows a burn through hole but did not burn;

FIG. 8A is a chart of flammability test labeled Report No. 3;

FIG. 8B is a photograph of 90 second flame contact time burn test results in Report No. 3 of FIG. 8B showing the burn test in progress on 2 mil aluminum foil;

FIG. 8C is a photograph of burn test results of 90 second flame contact time to the exposed side of the 2 mil foil side in Report No. 3 of FIG. 8B;

FIG. 9A is a chart of flammability test labeled Report No. 4;

FIG. 9B is a photograph of burn test results in Report No. 4 of FIG. 9A and shows no damage to the 2 mil foil after 240 seconds of flame contact;

FIG. 9C is a photograph of burn test results in Report No. 4 of FIG. 9A and shows the damage after 16 minutes of flame contact;

FIG. 9D is a photograph of burn test results in Report No. 4 of FIG. 9A and shows the damage to the polyurethane and adhesive bonded to the cement panel the undamaged area of adhesive tore cement and fibers from the cement board when the sample was removed after 16 minutes of flame contact.

### DETAILED DESCRIPTION

Embodiments of the present disclosure generally relate to a reinforced film for blast resistance protection and methods thereof. More specifically, embodiments of the present disclosure may be applied to surfaces of a structure, to give such surface greater structural integrity in the event of a blast, an explosion or other catastrophic event.

### General Structure of a Reinforced Film

FIG. 1 depicts a cross-section of a reinforced film in accordance with one exemplary embodiment of the present disclosure. Generally, a reinforced film 100 comprises at least an elastomeric polymer laminate 110, and an energy absorptive or dissipative layer 120 at least partially encapsulated within the elastomeric polymer laminate 110. In certain embodiments, a plurality of elastomeric polymer laminates 110 may be provided, whereby a layer 120 may be disposed between the layers of laminate 110. Optionally, the reinforced film 100 may further comprise an adhesive layer 130, and accompanying release liner 140.

The reinforced film 100, generally has an overall thickness between about 8 mils and about 50 mils. In one embodiment, the reinforced film 100 has a thickness between about 13.9 mils and about 15.3 mils. In another embodiment, the reinforced film 100 has a thickness of about 14.8 mils.

In accordance with certain embodiments of the present disclosure, the reinforced film 100 has a puncture resistance of between about 3,000 psi to about 25,000 psi. In another embodiment, the reinforced film has a puncture resistance of between about 10,000 psi to about 20,000 psi. In one embodiment, the reinforced film has a puncture resistance of at least 5,000 psi.

The elastomeric polymer laminate 110 may comprise any suitable elastomeric polymer composition. Generally, the elastomeric polymer laminate may include a material exhibiting advantageous tensile strength, puncture resistance, flex fatigue resistance, low temperature flexibility, high impact strength, chemical and hydrolysis resistance, and general elastomeric properties. Exemplary materials suitable for embodiments of the present disclosure include, but are not limited to, materials comprising at least one of urethane, silicone, polyethylene, polypropylene, natural and synthetic rubber and blends thereof, foam, other thermoplastic elastomers or polyolefins, mixtures and blends of the foregoing, or the like.

In certain embodiments, the elastomeric polymer laminate 110 comprises a thermoplastic urethane or blends thereof. In one embodiment, the elastomeric polymer laminate 110 comprises an aromatic, polyether-based thermoplastic polyurethane. Two exemplary aromatic, polyether-based thermoplastic polyurethanes suitable for embodiments of the present disclosure are commercially available from the Lubrizol Corporation (Cleveland, Ohio, formerly Noveon International, Inc.) under the trade names Estane 58887™ and ETE 50DT3™.

In certain exemplary embodiments of the present disclosure, blends of such commercially available thermoplastic polyurethanes are utilized in the elastomeric polymer laminate 110. An exemplary blend may comprise between about 30%-90% Estane 58887 by weight, and between about 10%-70% ETE 50DT3 by weight. In one embodiment, the blend comprises about 80% Estane 58887 by weight, and about 20% ETE 50DT3 by weight.

Certain embodiments comprise a multilayer elastomeric polymer laminate, where each layer of laminate may comprise different urethanes and/or different blends of urethane or other desired polymer. Each layer of laminate may incorporate other urethanes or polymers that provide different material properties. In one embodiment, a layer of laminate may comprise up to about 20% polyester-based thermoplastic polyurethane, for example, Estane 5713, commercially available from Lubrizol Corporation.

Optionally, the elastomeric polymer layer 110 may include one or more additives or stabilizers to enhance particular properties of the reinforced film 100. For example, in one exemplary embodiment, the elastomeric polymer layer 110 may comprise stabilizers to improve the UV resistance and deter thermal degradation.

In one exemplary embodiment, the stabilizers comprise a high molecular weight stabilizer. In another exemplary embodiment, the stabilizers comprise at least one hindered amine light stabilizer (HALS). In another exemplary embodiment, the light stabilizer comprises an ultraviolet light absorbing agent, such as 3,5-di-t-butyl-4-hydroxybenzoic acid, hexadecyl ester. In another embodiment, the light stabilizer comprises an ultraviolet light absorbing agent and free radical scavenger, commercially available from CYTEC Industries, Inc. (West Paterson, N.J.), under the name CYASORB® UV-2908. In another exemplary embodiment, the stabilizer comprises a UV light stabilizer, commercially available from Ciba Specialty Chemicals Corp. (Tarrytown, N.Y.) under the name Tinuvin™ 765.

Antioxidants may also be added to the elastomeric polymer laminate 110 in certain embodiments. The antioxidants may include, but are not limited to, hindered phenols or multifunctional phenols such as those containing sulfur or phosphorus. The performance of either the stabilizers or the antioxidants may be further enhanced by utilizing synergists such as, but not limited to, thiodipropionate esters and phosphites, chelating agents and metal deactivators, such as, but not limited to, ethylenediaminetetraacetic acid, salts thereof, and disalicylalpropylenediimine

In other exemplary embodiments, other agents may be incorporated into the elastomeric polymer laminate 110. In one exemplary embodiment, a fungicide is applied to the elastomeric polymer laminate 110 to resist fungal growth. Exemplary fungicides include miconazol, amphotericin B, nystatin, griseofulvin, and the like. Embodiments of the present disclosure may further comprise any bioactive agent or the like, to prevent any undesirable biological presence in the reinforced film.

The elastomeric laminate layer 110 may be provided in any suitable thickness for embodiments of the present disclosure. In one embodiment, the elastomeric laminate layer 110 is provided in a thickness between about 2 mils to about 75 mils. In another embodiment, the elastomeric laminate layer 110 is provided in a thickness between about 5 mils to about 50 mils.

The elastomeric laminate layer 110 may be transparent, translucent, or opaque, depending on the desired application of the reinforced film 100. Similarly, the elastomeric laminate layer 110 may any color, either natural, dyed or painted. Such coloring may be desirable to blend the reinforced film 100 into a surface, or create a visual obstruction for occupants on the inside of a structure reinforced by a reinforced film 100 of the present disclosure.

The layer 120 is an energy absorbing or dissipating material which contributes to the reinforced film 100 absorbing and/or dissipating energy from a blast. The layer 120 also acts in catching debris from the blast and prevent debris from injuring building occupants.

For the purposes of the present disclosure, the layer 120 is any suitable material having openings, windows, interstices, holes, pores, cells, combinations thereof, or other structures which permit, in a sandwich of the layer 120 between two elastomeric polymer layers, the fusion or through-bonding during manufacture of at least portions two layers of elastomeric polymer material through at least a portion of the layer 120. The layer 120 may be a woven or nonwoven material. The layer 120 may be a net, mesh, web, grid, lattice or the like, or may be another regular or irregular pattern. The layer 120 may be a fibrous or nonfibrous material. In one aspect of the present disclosure the layer 120 may be a fabric material, such as, but not limited to, PET, natural, synthetic, artificial fibers, blends, mixtures and combinations of all of the foregoing, and the like. In one aspect of the present disclosure the layer 120 may be a made of a fabric comprising a single strand of fibers, or may be comprised of a fiber having multiple strands of the same or different materials. For nonlimiting illustrative purposes, aspects of the embodiments discussed herein may refer to the layer 120 as “scrim layer 120,” and such references are intended to broadly encompass the composition of layer 120 as described herein. As discussed hereinbelow, in certain applications the layer 120 is not required.

In one exemplary embodiment, the scrim layer 120 comprises at least one of a plurality of aromatic polyamide fibers (commonly referred to as “aramid”), para-aramid fibers, meta-aramid fibers or the like.

Exemplary suitable materials for the scrim layer 120 include para-aramid fibers (e.g., Kevlar, Technora, Twaron, etc.), meta-aramid fibers (e.g., Nomex™, Teijinconex™, Kermel™, etc.) and other heat-resistant and strong synthetic fibers (e.g., sulfron, nylon, ultra high molecular weight polyethylene (UHMWPE), glass, carbon, metal or metal alloys, including copper, nickel, iron, steel, gold, silver, platinum, other conventional or high-tech alloy, etc.). In many embodiments, the scrim layer 120 comprises at least p-phenylene terephtalamides (commercially available as Kevlar™ and Twaron™) or poly-metaphenylene isophtalamides (commercially available as Nomex™ or Teijinconex™).

In certain exemplary embodiments of the present disclosure the fibers of the scrim layer 120 are provided having between about 1,000 to about 4,000 denier, depending on structure of the scrim layer and the desired strength of the reinforced film 100. In one embodiment the fibers of the scrim layer 120 are provided having a denier of about 3000. In many embodiments, the fiber thread count of the scrim layer 120 may range between about 1×1 to about 50×50, depending on the strength and material selection of the scrim layer 120.

In one exemplary embodiment of the present disclosure the reinforced film includes a scrim material comprising a bundle of strands. In one exemplary embodiment two strands of 3,024 denier aramid yarn were combined as a discrete bundle, resulting in the combined fiber bundle having a denier of 6,048. In certain exemplary embodiments single or combined strands fibers may have a denier of up to 10,000, or more. The practical limit on denier size is that the layer 120 permit the through-bonding of the elastomeric layers to each other through the layer 120. At some high denier the elastomeric material layer does not penetrate the layer 120 to bond to the other elastomeric material layer. It is to be understood that the through-bonding may occur such that one layer of elastomeric material passes through the layer 120 to bond to the other elastomeric layer, or that the material from both elastomeric layers enters the layer 120 to bond within the layer 120.

In one exemplary embodiment it is possible for the layer 120 to comprise pores, some of which do not extend entirely through from one side to the other side the layer 120. In such an embodiment, the elastomeric material from each layer may penetrate the layer 120 to bond to and within the pores.

One aspect of the present disclosure provides a scrim layer 120 comprising about 12-20 crossover points of fiber bundles (as described in greater detail herein below), and between about 6-15 windows (i.e., spacing between fiber bundles), per square inch. In another exemplary embodiment, the scrim layer 120 comprises about 16 crossover points, and about 9 windows, per square inch. Furthermore, the thickness of the scrim layer may have a range of about 0.5 mils to about 75 mils, with a fiber bundle width of about 0.005 inches to about 0.5 inches. In one exemplary embodiment, the thickness of the scrim layer is about 5 mils to about 25 mils, with a fiber bundle width of about 0.05 inches to about 0.15 inches.

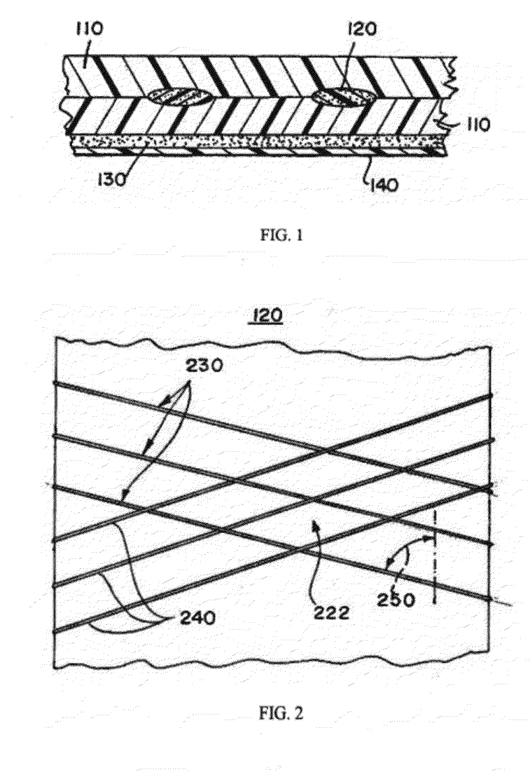

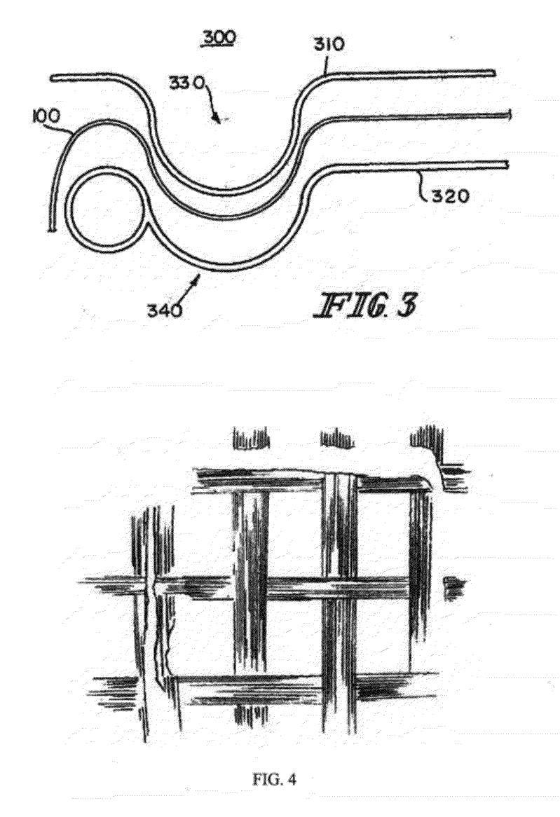

FIG. 2 is a schematic of the fiber scrim according with one exemplary embodiment of the present disclosure. In certain exemplary embodiments, the scrim layer 120 comprises a fiber weave or matrix to structurally increase the strength of the reinforced film 100. The fibers may be weaved into a predetermined shape or pattern. In one exemplary embodiment, the scrim layer 120 comprises a plurality of fibers forming a substantially diamond shaped pattern.

In one exemplary embodiment, as depicted in FIG. 2, the scrim layer 120 may comprise bi-directional fibers, or fiber bundles, 230 and 240, resulting in a diamond shaped pattern 220. In such an embodiment, an angle 250 is formed from a true warp direction 260 and the positioning of the bidirectional fiber bundles 230 and 240. In one exemplary embodiment, the angle 250 may be between approximately 40° and approximately 80°. In another exemplary embodiment of the present disclosure, the angle 250 may be between approximately 45° and approximately 60°.

Furthermore, the scrim layer 120 may comprise a tight weave of fiber bundles 230 and 240, such that the individual fiber bundles 230 and 240 are spaced closer together. Conversely, the scrim layer 120 may comprise a loose woven pattern, such that the fiber bundles 230 and 240 are spaced substantially apart from one another. In one embodiment of the present disclosure, the distance between the fibers of the scrim layer 120 may be between about 0.25 and about 0.75 inches, as calculated by measuring centerline to centerline of the bundles. In another embodiment, the spacing between the fibers may be between about 0.375 and about 0.5 inches.

The fiber bundles 230 and 240 of the scrim layer 120 generally comprise a substantially round or ovoid cross-section. In one embodiment, the fiber bundles 230 and 240 comprise a substantially flattened ovoid or rectangular cross-section, to decrease the thickness of the scrim layer 120.

In certain embodiments, the scrim layer 120 may further comprise an adhesive to bond the crossover positions of the bidirectional fiber bundles 230 and 240. Such adhesive may comprise any suitable adhesive composition for embodiments of the present disclosure, including any adhesive discussed herein. One exemplary bonding adhesive for the scrim layer 120 includes ethyl vinyl acetate (EVA), nylon, urethane, or the like.

Generally, the resulting strength of the scrim layer 120 may withstand a force of between approximately 80 lbs/lineal inch and approximately 1,000 lbs/lineal inch. In one exemplary embodiment, the scrim layer 120 may withstand a force of between about 200 lbs/lineal inch and about 600 lbs/lineal inch.

Optionally, the scrim layer 120 may comprise additional fibers (not shown) in the warp direction, to ensure good integrity of the finished scrim layer 120. These additional fibers may be constructed of any suitable material for embodiments of the present disclosure, including any material discussed herein. In one exemplary embodiment, the scrim layer 120 comprises additional nylon or light weight polyester fibers.

In one exemplary embodiment of the present disclosure, multiple scrim layers 120 may be used, such that each scrim layer 120 may be positioned substantially adjacent to each other, overlapped, separated by layers of laminate, or in any other configuration desirable.

The adhesive layer 130 may comprise any suitable adhesive for embodiments of the present disclosure. The adhesive layer 130 may comprise a pressure-sensitive adhesive (PSA). In certain exemplary embodiments, the adhesive layer 130 is a pressure-sensitive adhesive comprising at least one of silicone, natural or synthetic rubber, thermoplastic elastomer, polyurethane, water or solvent based acrylic, mixtures or combinations of the foregoing, or the like. In alternative exemplary embodiments, the adhesive layer 130 comprises at least one of an anaerobic, cyanoacrylate, epoxy, phenolic, polyimide, hot melt, butyl-based, plastisol, polyvinyl acetate (PVA), blends of the foregoing, or the like.

In one exemplary embodiment of the present disclosure, the adhesive layer 130 comprises an acrylic pressure-sensitive adhesive, commercially available under the name “National Starch 80-178 A,” from National Starch and Chemical (Bridgewater, N.J.). In another embodiment, the adhesive layer 130 comprises a urethane-based pressure sensitive adhesive, commercially available under the name “SZ-0670A PSA,” from Worthen Industries (Nashua, N.H.). Certain embodiments of the present disclosure contemplate the combination or blend of multiple types of adhesive compositions to achieve advantageous characteristics of the reinforced film 100.

Antioxidants may also be added to the adhesive layer 130 in certain embodiments. The antioxidants may include hindered phenols or multifunctional phenols such as those containing sulfur or phosphorus. In one embodiment, the adhesive layer 130 comprises an antioxidant, commercially available under the name “BNX-1225 Mayzo™,” from McDonald (Pa.). The adhesive layer 130 may further comprise solvents suitable for embodiments of the present disclosure. In one embodiment, a solvent comprises methylbenzene or phenylmethane, commonly known as toluene.

The performance of the adhesive layer 130 may be further enhanced by utilizing synergists, for example, thiodipropionate esters and phosphites, or chelating agents, metal deactivators, for example, ethylenediaminetetraacetic acid, salts thereof, and disalicylalpropylenediimine, or catalysts, for example, isocyanate-catalysts, hydroxyl-catalysts and the like. In one embodiment, the adhesive layer 130 further comprises an isocyanate-catalyst, commercially available under the name Mondor MR-Light™ from Mozel Industries (Columbia, Ill.).

Optionally, the adhesive layer 130 may include additives or stabilizers to enhance particular properties of the adhesive. For example, in one exemplary embodiment, the adhesive layer 130 may comprise at least one stabilizer to improve the UV resistance and deter thermal degradation.

In one exemplary embodiment, the adhesive stabilizer comprises a high molecular weight stabilizer. In another embodiment, the stabilizers comprise at least a hindered amine light stabilizer (FIALS). In another embodiment, the light stabilizer comprises an ultraviolet light absorbing agent, such as 3,5-di-t-butyl-4-hydroxybenzoic acid, hexadecyl ester. In another embodiment, the light stabilizer comprises an ultraviolet light absorbing agent and free radical scavenger, commercially available under the name CYASORB® UV-2908. In another embodiment, the stabilizer comprises a UV light stabilizer, commercially available under the name Tinuvin™ 765.

In one exemplary embodiment of the present disclosure, the adhesive layer 130 is provided in a composition comprising between about 70.0% to about 95.0% of an acrylic pressure-sensitive adhesive, between about 5.0% to about 15.0% urethane-based pressure-sensitive adhesive, between about 0.0% and about 1.5% antioxidant, between about 1.0% and about 2.0% of a solvent, and between about 0.0% and about 1.0% of a catalyst. In another embodiment of the present disclosure, the adhesive layer may comprise about 86.56% acrylic pressure-sensitive adhesive, about 11.08% urethane-based pressure sensitive adhesive, about 0.75% antioxidant, about 1.5% toluene, and about 0.11% isocyanate catalyst.

The adhesive layer 130 may be between about 2 mils to about 75 mils thick. In one embodiment, the adhesive layer 130 is between about 6 mils to about 10 mils thick. In another embodiment, the adhesive layer 130 is between about 6.8 mils to about 7.2 mils thick.

The optional release liner 140 may be applied to an exposed side of the adhesive layer 130. The release liner 140 material may be a silicone liner material, or non-silicone liner material, such as polyvinyl octadecylcarbamate. Other types of release liners 140 include, but are not limited to, polyvinyl stearylcarbamate, vinyl acrylic emulsion release liner material, and a fluorochemical emulsion with an acrylic backbone.

In alternative exemplary embodiments, the release liner 140 may be provided as a layer applied on the elastomeric polymer laminate 110. In such an embodiment, if the reinforced film 100 is provided in a roll, the force required to unroll the reinforced film 100 is substantially less than it would be with a reinforced film 100 of the present disclosure provided without such a release liner 140. In one such embodiment, the release liner 140 may comprise a non-silicone material, for example polyvinyl octadecylcarbamate or polyvinyl stearylcarbamate.

The optional release liner 140 may comprise any additional material necessary to provide material characteristics suitable for embodiments of the present disclosure. In that regard, the release liner 140 may also serve a secondary purpose, for example, in active combat situation as a floor covering or general purpose tarp. As such, the release liner 140 may comprise a substantially resilient material, such as nylon, vinyl, urethane, polyester, or the like.

### Manufacturing a Reinforced Film

Manufacturing a reinforced film 100, in accordance with certain exemplary embodiments of the present disclosure, may be performed using any conventional film manufacturing process. In certain exemplary embodiments, the layers of the reinforced film are manufactured in accordance with at least one of an extrusion, lamination or calendaring process.

In one exemplary embodiment, a reinforced film 100 may be manufactured in accordance with the following steps. The elastomeric polymer laminate 110 is prepared by extruding or calendaring a molten resin at a temperature between about 350 degrees Fahrenheit to about 500 degrees Fahrenheit, to form a laminate of desired thickness. The scrim layer 120 may be laminated to the molten laminate layer by passing through a nip roller at a pressure between about 30 psi to about 50 psi, and a roller temperature between about 50 degrees Fahrenheit to about 120 degrees Fahrenheit. An additional layer of molten resin may be applied over the exposed scrim layer to form an encapsulation of the scrim layer 120, and a reinforced film 100 in accordance with embodiments of the present disclosure.

Optionally, an adhesive layer 130 may be applied by laminating, transfer coating or direct coating on the reinforced film 100. Such adhesive layer 130 may be applied inline with the above steps, or as a separate process.

The resulting reinforced film 100 may be manufactured in rolls, sheets, or tape form, for ease of transport and installation. In one embodiment, the reinforced film 100 is manufactured in sheets.

### Application of Reinforced Film

Certain exemplary embodiments of the film of the present disclosure may be applied to the surface of an object or structure for purposes of increasing the structural integrity of such surface. In many embodiments, the reinforced film 100 of embodiments of the present disclosure is attached to an interior or exterior wall of a dwelling or building to provide additional strength to the wall on which the reinforced film 100 is applied.

In one embodiment of the present disclosure, a reinforced film 100 comprising an adhesive layer 130 and release liner 140 is provided for application to a wall of a building. Generally, the release liner 140 may be removed to expose the adhesive layer 130 which subsequently is affixed to the wall in a “peel-and-stick” fashion. Optionally however, to facilitate a stronger bond between the reinforced film and the wall to be protected, upon removal of the release liner 140, the wall or surface may be coated with a primer or other chemical to facilitate stronger and/or faster bonding with the adhesive layer 130 on the reinforced film 100.

Alternatively, a second adhesive may be applied to the target surface (i.e., the wall of the structure) to enhance the bonding properties between the surface and the reinforced film 100. For example, a primer and/or adhesive may be sprayed, brushed or otherwise applied to the surface to be protected, prior to the application of the reinforced film 100. Similarly, initial cleaning of the target surface may also be desirable for better bonding. In accordance with embodiments of the present disclosure, additional adhesives, primers or chemicals may comprise any material or composition disclosed herein, or any additional suitable material or composition, as understood by those of ordinary skill in the industry.

In certain exemplary embodiments of the present disclosure, the reinforced film 100 is provided without an adhesive layer 130. In such embodiments, affixing the reinforced film 100 to surfaces to be protected may utilize any suitable connection, fixation, or fastening means. In one embodiment, fastening means include, but are not limited to chemical fasteners (e.g., adhesives, epoxies, and the like) or mechanical fasteners (e.g., staples, nails, screws, bolts, clamps, or the like).

In one exemplary embodiment, the reinforced film 100 may be anchored to a wall, ceiling, or other desired structure, using clamps. Generally, a clamp comprises any suitable material, for example, any metal or polymer. A clamp affixes the reinforced film 100 to a surface by bracing itself into the frame of the structure, and providing sufficient force to retain the film against the desired surface. In one exemplary embodiment, a clamp may be used in conjunction with an adhesive on the reinforced film 100 to attain enhanced reinforcement properties. Such type of clamp is generally known in the industry, and in one embodiment is disclosed by U.S. Pat. No. 6,904,732, the disclosure of which is incorporated by reference herein in its entirety.

FIG. 3 depicts an exemplary clamp for use in fastening the reinforced film to a surface, in accordance with one embodiment of the present disclosure. As shown in FIG. 3, the clamp 300 comprises a first mounting bracket 310 and a second mounting bracket 320. Generally, each mounting bracket has a paired recessed portion 330, such that the recessed portion 340 of the first mounting bracket 310 mates within the recessed portion 350 of the second mounting bracket 320. In one embodiment, to secure a reinforced film 100, as depicted in FIG. 3, the pair of mounting brackets 310 and 320 may have a portion of the reinforced film 100 in substantially positioned in between the two brackets 310 and 320, and the respective recessed portions, and thus secures the reinforced film 100 in place.

Alternative embodiments of the present disclosure provide a reinforced film 100 may be manufactured directly onto, into with or against building or construction materials. For example, a reinforced film 100 may be adhered, laminated, extrusion coated, or fastened to a building material at the time of manufacture of the building construction material or at a time prior to distribution of the building materials. Exemplary building materials include, but are not limited to, wall panels, cellulosic sheets, plywood, drywall, Forticrete™, cinder blocks, walling stone, brick, house wrap, sheathing, and the like.

In one exemplary embodiment, the reinforced film 100 is affixed to a sheet of drywall or plywood using any fastening means as disclosed herein or other technique. In another embodiment, the reinforced film 100 is provided as an extruded or laminated layer contained within the material construction of a cellulosic sheet or sheathing. In any such embodiment, structures may be built using standard construction techniques without the requirement of a specialist or technician on-site to apply the reinforced film 100 after the structure is built.

In many embodiments, it may be desirable to apply multiple layers of the reinforced film 100 on a surface. Generally, in order to apply multiple layers of reinforced film 100 on a surface, the processes discussed herein for applying a single layer of reinforced film 100 may be repeated (i.e., a subsequent layer may be applied on a first layer), until a desirable number of layers are covering a surface.

### Protected Structures

The reinforced film 100 of embodiments of the present disclosure is capable of protecting many different types of surfaces and structures. The surfaces to be protected by embodiments of the present disclosure may comprise concrete, brick, wood, asphalt, glass, cellulosic fibers, dirt, clay, metal, plastic, or any other material generally used to construct surfaces of structures as described herein.

Generally, the reinforced film 100 may be applied to an interior-facing surface of an exterior wall of a building or other walled structure. The reinforced film 100 may also be applied to an outer-facing surface of an exterior wall, typically underneath an outer coating of building (e.g., siding, shingles, etc.). The reinforced film 100 increases the structural integrity of such wall surfaces, thus increasing critical extra time for occupants to exit or remove equipment from the structure before a possible structure collapse. The increased structural integrity may also prevent any exterior wall material from significantly penetrating the interior of the structure, thereby preventing injury to the occupants from flying debris and severe wall detent or deformation.

In another example, the reinforced film 100 may be applied to the inside and/or outside surfaces of armored or unarmored transport vehicles. The reinforced film 100 provides increased structural strength to the vehicle walls and/or other surfaces. Such an application may prevent or minimize injury to occupants of a vehicle, during an explosion or other assault.

In other embodiments, the reinforced film 100 may also be used in post-damage remedial actions. For example, damage to a vehicle may be temporarily fixed by applying the reinforced film 100 to a damaged area to provide the necessary remedial support so as to prevent further degradation to the damaged area.

In yet another embodiment, the reinforced film 100 may be used as structural reinforcement to non-occupant structures, such as levees and dams. For example, a reinforced film 100 may be applied to an inward-facing and/or outward-facing surface of a levee to increase its structural integrity and potentially prevent its rupture, or at a minimum, provide sufficient additional structural integrity until adequate preventative measures become available.

### Safe Room

In accordance with certain exemplary embodiments of the present disclosure, a reinforced film 100 may be utilized to create a safe room. A safe room, as understood by those of ordinary skill in the industry, is generally defined as a room in a building or other structure, having structurally reinforced walls, including a ceiling, a floor and side walls, such that the entire room is encapsulated by some form of structural reinforcement. In one embodiment, a reinforced film 100 is applied to every interior surface in a room, including any side walls, the ceiling and the floor, to create a safe room. The reinforced film 100 may also or alternatively be applied to each exterior surface, opposing each interior surface in a room.

To build a safe room, the reinforced film 100 (with or without the layer 120) may directly be adhered or affixed to the surfaces of a currently existing room, either in single or multiple layers, using methods discussed herein. Alternatively, if the walls of a safe room have not yet been constructed, a safe room may be built using known building materials comprising at least a layer of reinforced film 100 on or within the material composition. In accordance with one embodiment of the present disclosure, if a safe room is constructed using building materials comprising a reinforced film 100, additional layers of the reinforced film 100 may be applied to the building materials after basic installation and construction of the walls is complete.

One feature of the reinforced film of present disclosure in certain embodiments in which a layer of scrim material is sandwiched between two elastomer material layers is that at least a portion of the elastomer layers are fused and bonded to each other through the openings or windows in at least a portion of the scrim material (e.g., aramid fibers). The reinforced film may exhibit a degree of “slippage” between the two elastomeric layers and the layer 120 when the film is applied to the surface of a wall and the wall is subject to bending forces, such as could occur in a blast event. As the layer 120 is not fixed or constrained at its ends or sides, connections with this slippage allowing for more efficient absorption or dissipation of energy from an event such as a blast or like event which will transmit a tensile force along the length of the fiber bundles in the fibrous layer. The layer 120 is relatively nonelastic, compared to the elastomeric layers. The elastomeric layers alone would stretch too much during a blast, allowing the stretching of the film into the room too much. The addition of the layer 120 restricts the elasticity of the elastomeric layers. Putting the layer 120 on a generally 45 degree angle allows the fibers (as an example) to “float” to a certain degree, thus limiting the stretching of the overall film and helping to absorb or dissipate the blast force. The result of this slippage is that the film material can absorb more blast force without puncture or rupture than nontreated materials, thus aiding in maintaining the wall structure and reducing the incidence of wall structure failure as a result of a blast force.

Additionally, the adhesive material (which is used to apply the film of the present disclosure to a wall or ceiling structure) contributes to energy absorption or dissipation ability of the film of the present disclosure by causing the wall blocks (e.g., bricks, cinder blocks or other structural units the wall or ceiling is made of) to act as a unitary structure, thus spreading out the force of the blast over a number of blocks, rather than the force acting on the individual blocks alone.

In tests of the presently disclosed reinforced film (without flame retardant material) which had been applied to a cinder block wall which was subjected to repeated direct impacts by 2×4 inch wood boards being “shot” at the wall, the wall structure held as well as a wall (without the present film) protected with an equivalent of three sheets of % inch stacked plywood layers.

Because of its mass and construction it difficult to incorporate a flame retardant (“FR”) material within the polymer of the presently disclosed reinforced film, as doing so would likely change the physical characteristics of the overall construction and may inhibit the bonding of the two layers of the polyurethane, making it unusable.

A feature of the present disclosure is to provide flame retardant properties to the presently disclosed reinforced film. Additionally, it is desirable that anything employed to make reinforced film FR not be of any appreciable chemical or physical hazard to the area being protected.

One aspect of the present disclosure provides adding a flame retardant material to the outside surface of the reinforced film open to the room or facing into the room.

Aluminum foil or other metals added through a metallization process may insulate the polyurethane from heat thus preventing it from reaching its melt point and adding to a fire. The reinforced film may be laminated with a glass cloth or other insulating fabrics or constructions from 0.5-10 mils in thickness to provide an insulating heat barrier on the surface of the film.

In another aspect of the present disclosure the glass cloth or insulating layer may be metalized with a verity of type of metalizing materials, such as, but not limited to, aluminum, tin or blends of both metals. Materials such as ceramics, plasma-coated ceramics, Nomex™, or other insulating or plasma coating flame retardant materials may be used. Alternatively, the metallization or plasma coatings may be done directly on the surface of the urethane.

The insulating materials when in a web form, like glass cloth, may provide a casting medium in the first pass of the reinforced film simplifying the process and reducing scrap.

A further exemplary embodiment of the present disclosure provides a method for adding an insulating layer through the use of various adhesive systems, such as, but not limited to, solvent, one hundred percent solids, both pressure sensitive, heat activated, water activated, solvent activated or other media. A two-part system may be used with one part containing a catalyst, accelerator, or cross linking agent. Systems with additional catalyst or self contained systems may be used. The systems may be acrylic polymers, silicones, urethanes, rubber elastomers, RTV (room temperature vulcanizing) epoxies, or the like, and may be aromatic, aliphatic, aerobic, or anaerobic in nature. A two part pressure sensitive system may be used in which one part may contain the crosslinking agent for the other part and when the two pressure parts come together crosslinking takes place both chemically and physically changing the adhesive.

Any FR material applied to the surface of the reinforced film preferably has a certain amount of “slip” or movement between the FR material and the film layer so that the FR material can move or flex with the film during a blast event, thereby avoiding restriction of the film's ability to absorb blast energy. It is also desirable for the FR material not to create an additional hazard such as harmful flying debris or any release of harmful chemical liquid or gas.

In another exemplary embodiment aluminum foil may be bonded directly to the surface of the urethane or to an insulating layer. In another form the insulating layer may first be bonded to the foil and then the urethane may be cast on it or it may be bonded with an adhesive system. The advantage of straight foil can be more elasticity. The advantage of an insulator like glass cloth can be grater heat resistance. In the latter case elasticity may be regained by using an adhesive to laminate the substrate to the reinforced film. The thickness of the foil may be as described above.

The adhesive formula used to bond the foil to the film in the Example hereinbelow was used because it is designed to bond to the particular reinforced film construction used, however, other adhesives may work satisfactorily and the coating thickness could vary as low as 1-7 mils, or more.

In an alternative exemplary embodiment it may not be necessary to use an adhesive as the urethane can be cast directly onto the foil.

Other heavy foil thickness would be expected to work; such as, but not limited to, 5 mil foil, 7 mil foil and so on. Thicker foils will allow a longer flame contact time and may allow a larger buildup of gas as the urethane melts. This solution may allow film material of the present disclosure to be used on the ceiling of the room, if desired.

Other flexible FR web materials may also be used. The FR material can be painted or wallpapered. The FR material also can be grounded allowing for protection from electronic eavesdropping.

In one exemplary embodiment the reinforced flame retardant film material may be formed by extrusion lamination of the reinforced film and the FR material.

An unexpected aspect of the FR reinforced film was that the foil spread out the heat and acted as a heat sink to prevent or reduce flow of polyurethane. If installed in commercial building ceilings the FR reinforced film of the present disclosure can prevent or reduce offgassing or dripping of the polyurethane, which could otherwise potentially melt and drip on occupants during a fire. Also, the FR reinforced film of the present disclosure may prevent or reduce exposure of molten polyurethane to flammable gas, which could ignite.

In one exemplary embodiment, the FR material may be a panel or sheet, but, alternatively, may be a mesh, web, grid, matrix, lattice, woven or nonwoven fabric or metallic material, coating, combinations of the foregoing, or other structure. The FR material may be made of a single flame retardant material. The FR material may be made of a metal, metallic material, metalized material, metalized glass cloth, polyethylene terephthalate, polypropylene or other flexible material or the like. The FR material may be a blend of materials or a laminate of layers at least one component of which is or contains a metal, metallic or metalized material. The FR material may be applied to the reinforced film as a single layer or may be applied as multiple layers. In one exemplary embodiment there may be one or more insulative layers of air between layers of the FR material, such as a configuration whereby a mesh, web, grid, matrix or lattice layer having interstices, cells, pockets, pores, or the like which can retain or allow air or other gas or fluid to be retained.

In one exemplary embodiment, the present disclosure provides a structural wall or ceiling material or panel having a wall or ceiling layer composed of or from a material, such as, but not limited to, wood, drywall, gypsum (e.g., Sheetrock™), lath, plaster, cement, cinder block, brick, mud, grid (e.g., metal), compressed fiber, cellulose or cellulosic material, corrugated fiber, sandbags, containers filled with material (e.g., dirt, sand, rocks, gravel, wood chips, metal scrap, or the like) and combinations and mixtures of the foregoing. Alternatively, a grid or lattice scaffold may be used over which a layer of wall or ceiling material is applied, such as, but not limited to, cement, lath, mud, or the like. One or more layers of the foregoing may be used. To the wall or ceiling layer is associated a layer of the reinforced film as described in this disclosure to which is associated one or more layers of a FR material.

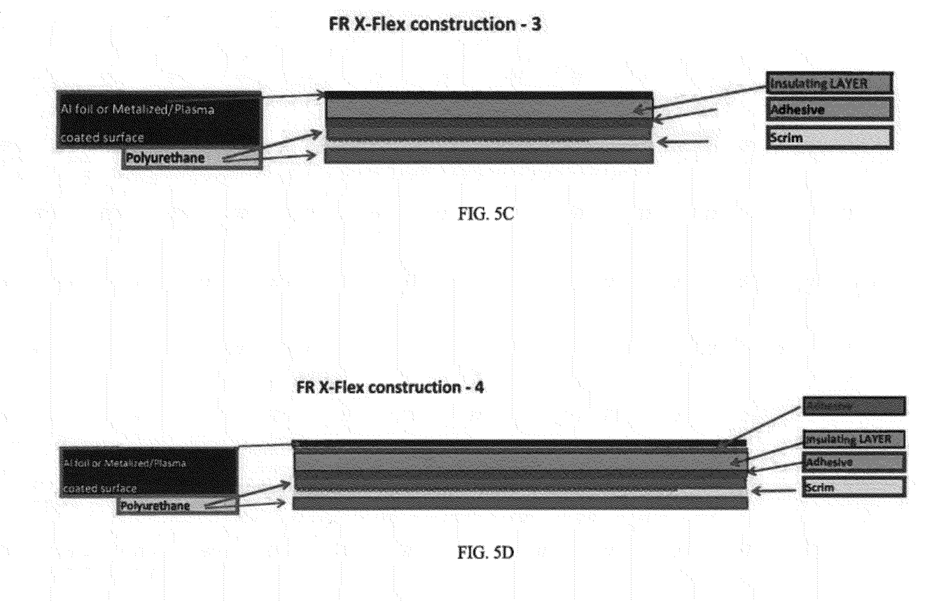

Four exemplary constructions of a reinforced flame retardant film material are shown in FIGS. 5A-D. FIG. 5A is a schematic view of a first exemplary layer construction of a reinforced flame retardant film material in which the polyurethane film is cast directly on the foil. FIG. 5B is a schematic view of a second exemplary layer construction in which the aluminum foil is adhesive coated and laminated to the polyurethane. FIG. 5C is a schematic view of a third exemplary layer construction in which the aluminum foil is laminated to a flame retardant insulating layer, such as, but not limited to, glass cloth and then adhesive coated and laminated to the polyurethane. FIG. 5D is a schematic view of a fourth exemplary layer construction in which the insulated layer is laminated to an adhesive coated aluminum foil and then a second adhesive is coated on the insulated side of the laminate and laminated to the polyurethane.

In certain applications and certain exemplary embodiments, the flame retardant reinforced film of the present disclosure may have the structure as disclosed herein, but without the presence of the layer 120.

### EXAMPLES

### Example 1

Tables 1 and 2 below depict ⅓ scale testing results of a reinforced film 100 in accordance with embodiments of the present disclosure.

For purpose of testing, a reinforced film 100 comprising a elastomeric polymer laminate comprising a urethane blend of about 80% Estane 58887 and about 20% ETE 50DT3 was utilized. The scrim layer 120 comprises Kevlar fibers at about +/−60° orientation with a minimum of about 0.25 inch spacing between the fiber bundles in the scrim layer 120.

As shown in Table 1, the film had an average thickness of about 14.8 mils, and ranged in thickness between about 13.9 mils and about 15.3 mils.

TABLE 1
Film Thickness (in mils)
Film Thickness (in mils)
Test Method: ASTM D-3652

| | Roll Section | | |
|---|---|---|---|
| Sample | Left | Middle | Right |
| 1 | 14.8 | 15.3 | 14.8 |
| 2 | 14.6 | 15.4 | 14.7 |
| 3 | 13.9 | 14.7 | 15.3 |
| 4 | 14.3 | 15.0 | 14.2 |
| 5 | 14.9 | 15.0 | 15.1 |
| Mean mils | 14.5 | 15.1 | 14.8 |
| | Average | 14.8 | |
| | STDV | 0.3 | |

As shown in Table 2, tensile strengths and elongation percentages were measured.

TABLE 2
Tensile and Elongation
Tensile and Elongation

| Test Method: ASTM D-3759 | | | |
|---|---|---|---|
| Sample Size: 4 Inches | | | |
| Equipment: Instron 3345 | | | |
| Load Cell: 200 lbs | | | |
| Jaw Separation: 2 inches | | | |
| Crosshead Speed: 2 inches/min. | | | |
| | Tensile (lbs/in) | | Elongation |
| | Lbs/in | psi | % |
| Left | | | |
| 1 | 131.6 | 8891.9 | 519.9 |
| 2 | 149.5 | 1010.4 | 551.8 |
| 3 | 151.1 | 10209.5 | 548.0 |
| 4 | 144.7 | 9777.0 | 531.8 |
| 5 | 147.3 | 9952.7 | 551.8 |
| Mean | 144.8 | 9786.5 | 540.7 |
| Middle | | | |
| 1 | 136.2 | 9202.7 | 497.5 |
| 2 | 147.3 | 9952.7 | 499.7 |
| 3 | 150.5 | 10168.9 | 511.8 |
| 4 | 140.9 | 9520.3 | 499.3 |
| 5 | 151.4 | 10229.7 | 522.2 |
| Mean | 145.3 | 9814.9 | 506.1 |
| Right | | | |
| 1 | 150.8 | 10189.2 | 528.8 |
| 2 | 136.9 | 9250.0 | 492.8 |
| 3 | 141.6 | 9567.6 | 516.3 |
| 4 | 135.3 | 9141.9 | 484.7 |
| 5 | 141.6 | 9567.6 | 511.5 |
| Mean | 141.2 | 9543.2 | 506.8 |
| Average | 143.8 | 9714.9 | 517.9 |
| STDV | 2.2 | 149.3 | 19.7 |

The tensile strength average was about 9,714 psi, or about 143 lbs/lineal inch of width tensile strength, and the percent elongation range was about 497% to about 551%. In a full scale test, the tensile strength approximates about 600 lbs/lineal inch as measured parallel to the aramid fiber orientation.

During the ⅓ scale testing, the adhesive layer 130 used on the reinforced film 100 required about 11 lbs of force per lineal inch to peel the adhesive from the surface of a standard size concrete block using a 180° reverse peel test. The adhesive layer 130 further required about 10 lbs of force per lineal inch to peel the adhesive from the surface of a standard sized American cinderblock using a 180° reverse peel test. In further testing of the adhesive layer 130 applied to the reinforced film 100, a standard size concrete block was adhered to the surface of the adhesive in a free hanging test, which took over about 1.5 hours for the free hanging concrete block to pull away from the adhesive layer 130.

Table 3 depicts the results of a puncture test of a reinforced film 100 in accordance with embodiments of the present disclosure.

TABLE 3
Puncture Results by Location
Puncture Results by Location
Puncture in (Lbs)
0.166″ radius probe @ 2 inches/min

| Sample | Single Layer | Double Layer | Triple Layer |
|---|---|---|---|
| Urethane Window | | | |
| 1 | 97.17 | 121.50 | 233.85 |
| 2 | 126.47 | 194.26 | 184.07 |
| 3 | 123.48 | 200.64 | 220.20 |
| 4 | 114.46 | 166.55 | 240.67 |
| 5 | 102.50 | 202.20 | 202.50 |
| Average | 112.82 | 183.03 | 216.26 |
| Crossed Scrim | | | |
| 1 | 209.06 | 256.34 | 576.61 |
| 2 | 240.87 | 233.94 | 425.12 |
| 3 | 261.61 | 289.04 | 543.67 |
| 4 | 192.39 | 321.99 | 583.65 |
| 5 | 268.52 | 224.24 | 544.79 |
| Average | 234.49 | 265.11 | 534.77 |
| Flat Scrim | | | |
| 1 | 107.42 | 212.38 | 244.93 |
| 2 | 114.95 | 148.81 | 208.48 |
| 3 | 106.29 | 189.90 | 239.74 |
| 4 | 126.17 | 174.44 | 195.73 |
| 5 | 94.62 | 210.24 | 261.04 |
| Average | 109.89 | 187.15 | 229.98 |

In accordance with the testing parameters, the reinforced film 100 was tested at three locations for puncture resistance: a urethane window (i.e., through the spacing in the scrim layer), a flat scrim (i.e., through a set of scrim fiber bundles), and crossed scrim (at a position of the overlap of bidirectional scrim fiber bundles). The reinforced film 100 was tested as single, double and triple layered. For each of the single, double and triple layers, the quantity of each location on a 1 square inch piece of reinforced film was determined.

Table 4 shows the average puncture resistance for each location was multiplied by the quantity of each location in an area of 1 square inch of reinforced film, and the sum of all three location results was then calculated.

TABLE 4
Determination of Force needed to Puncture One Square Inch

| | | Average Puncture | | |
|---|---|---|---|---|
| | Quantity per | Single | Double | Triple |
| | Square Inch | Layer | Layer | Layer |
| Urethane Window | 9 windows | 112.81 | 183.03 | 216.26 |
| Flat scrim | 24 fiber bundles | 109.89 | 187.15 | 229.98 |
| Crossed Scrim | 16 crossover points | 234.49 | 265.11 | 534.77 |

| | | | |
|---|---|---|---|
| Total Force (lbs) to Puncture 1 in² | 7404.49 | 10380.63 | 16022.18 |

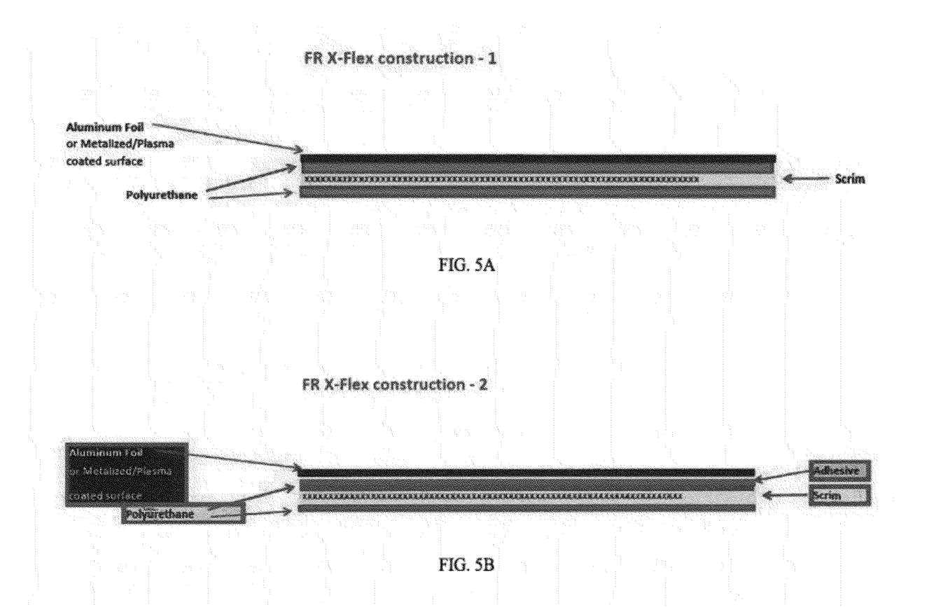

FIG. 4 depicts one exemplary embodiment of a reinforced film used during experimental puncture resistance testing in accordance with embodiments of the present disclosure.

### Example 2

### Burn Test Method

BMS-7230—Method F5 45 degree burn test method (formerly ASTM F1103-93, “Standard Test Method for Materials Response to Flame—45° (For Aerospace Vehicles)”), with increased flame exposure times, was used to obtain the data in this Example. This test employed an intense heat on a small area of sample for analyzing differences between foil laminates.

0.000285 inch (0.285 mil), 0.001 inch (1 mil) and 0.002 inch (2 mil) aluminum foils were used. The foils were coated with 7 dry mil of Bristol AF230 acrylic hybrid formulation and then laminated to the film composition of Example 1.

### Results

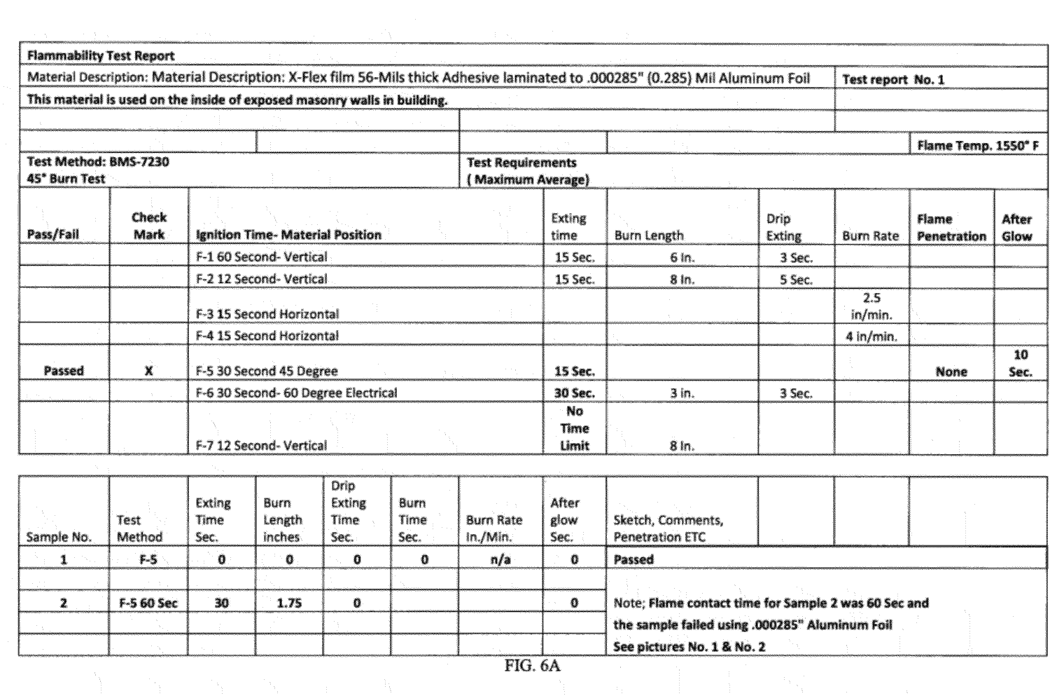

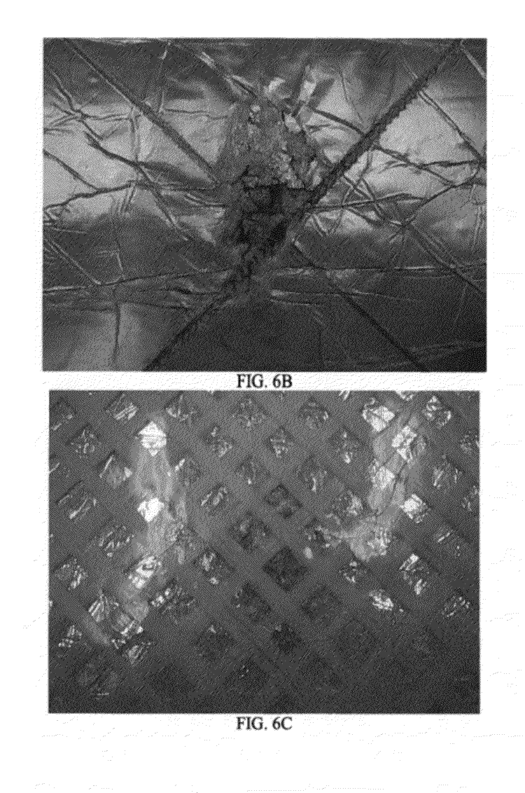

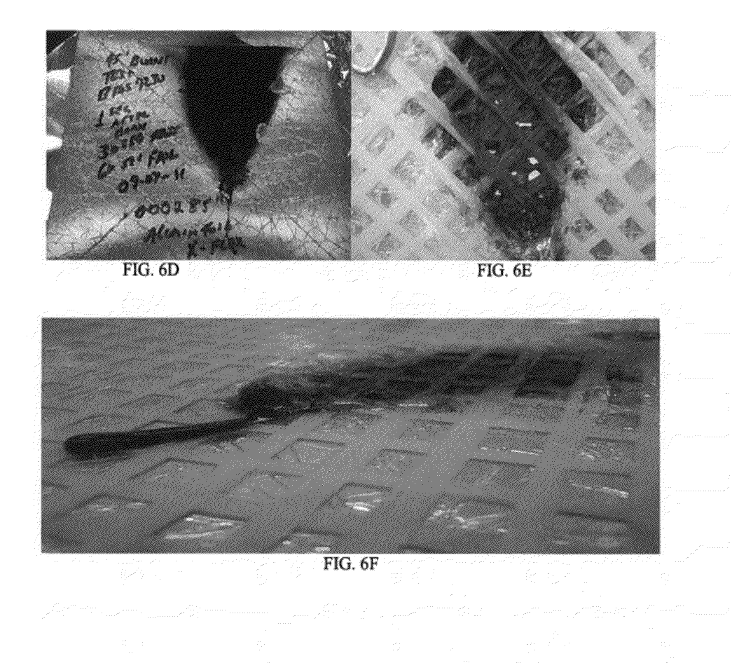

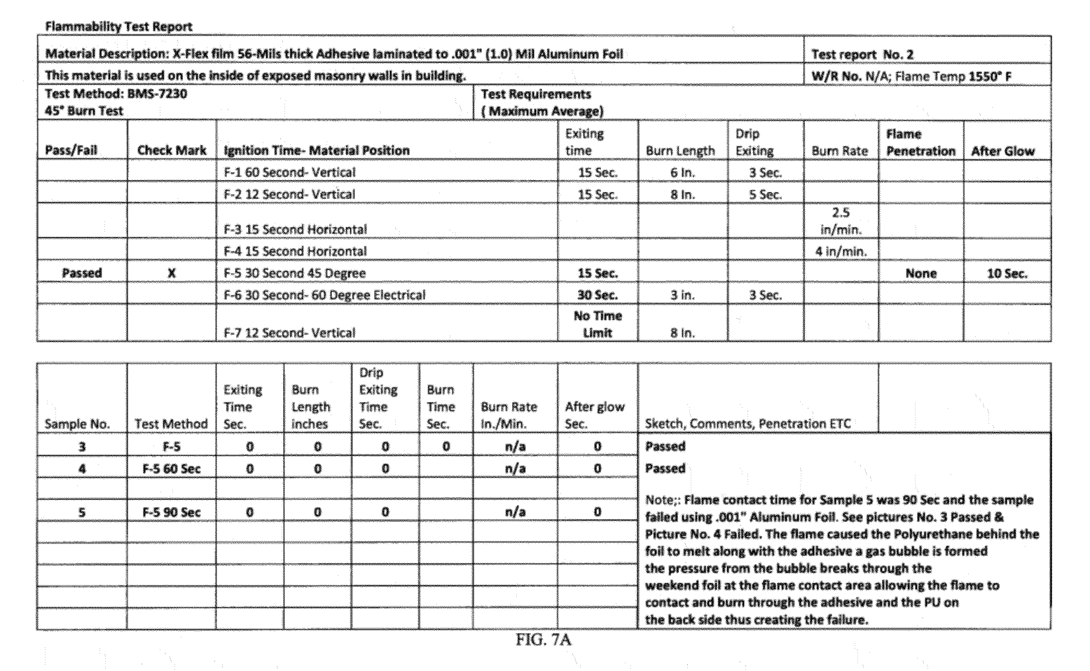

In Test No. 1 a 0.000285 inch (0.285 mil) foil laminate was tested. The laminate did pass the 30 second flame contact with a little damage to the foil. Next the flame contact time was extended to 60 sec. The foil was destroyed allowing the flame to set the molten urethane on fire. This free standing sample was not bonded to anything. See FIGS. 6A-F. FIG. 6A is a chart of flammability test Report No. 1. FIG. 6B is a photograph of passed burn test results of 0.285 mil aluminum foil side which passed after a 30 second flame contact time to the foil side. FIG. 6C is a photograph of passed burn test results of polyurethane side without a PSA coating present and a 30 second flame contact time to the exposed 0.285 mil foil side. FIG. 6D is a photograph of burn test results of a failed 60 second flame contact time aluminum foil side of the 0.285 mil foil. FIG. 6E is a photograph of burn test results of a failed 60 second flame contact time to the 0.285 mil foil side showing the melted and burned polyurethane. FIG. 6F is a photograph of burn test results of a failed 60 second contact time to the exposed 0.285 mil foil side showing the molten flow of the burnt polyurethane.

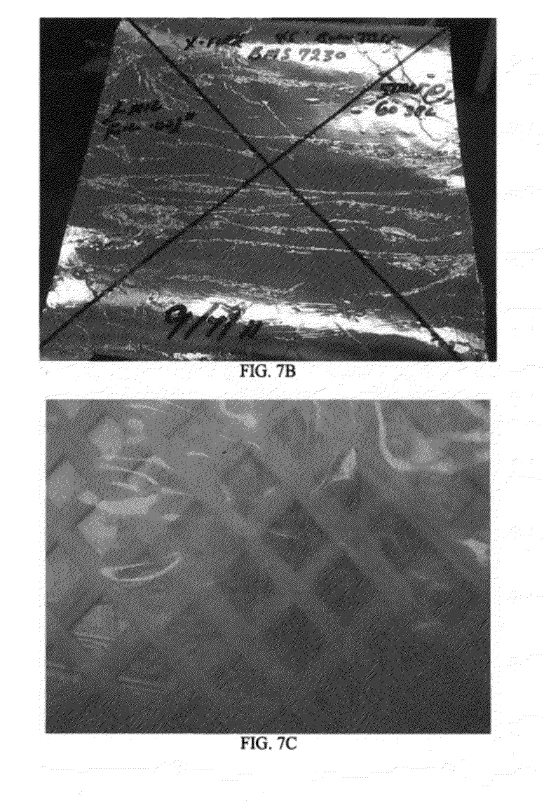

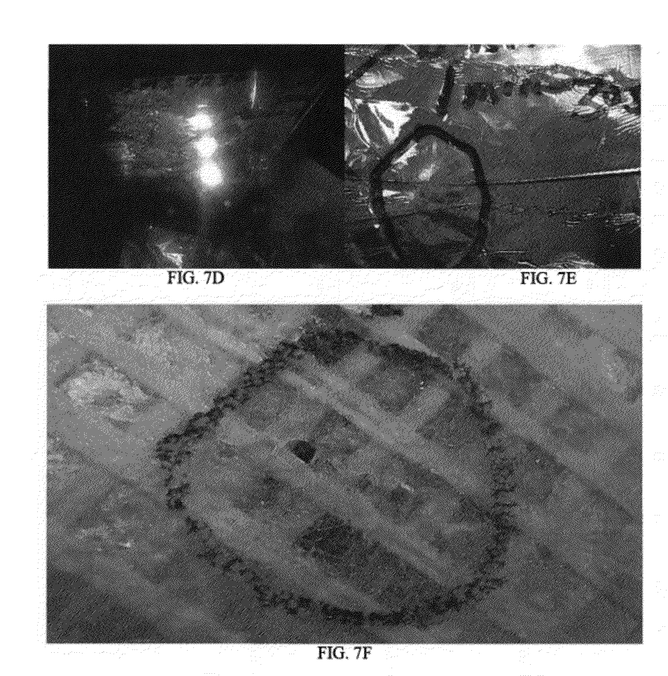

In Test No. 2 a 1 mil foil laminate was tested. This free standing laminate passed 30 sec and 60 sec flame contact times. The 90 sec flame contact time failed. The heat from the flame melted the urethane behind the foil. A gas bubble formed. The foil failed at the flame contact point from the pressure of the gas that is formed by the melting urethane. However the sample did not burn in an open flame the urethane just melted away and remained trapped behind the foil. See FIGS. 7A-F. FIG. 7A is a chart of flammability test labeled Report No. 2. FIG. 7B is a photograph of the passed burn test result after contact of the flame at 1550° F. to the 1 mil exposed foil side of the laminate for 60 seconds. FIG. 7C is a photograph of the passed burn test result after contact of the flame at 1550° F. for 60 seconds to the exposed 1 mil foil side showing little damage to the polyurethane or the top coating of adhesive on the polyurethane side. FIG. 7D is a photograph of the failed 90 second burn test result showing the burn test in progress to the exposed foil side. FIG. 7E is a photograph of the failed 90 second burn test result showing pinpoint burn through to the 1 mil foil. FIG. 7F is a photograph of the failed burn test result showing burn through on the polyurethane on the opposite side of the exposed 1 mil foil. The adhesive also shows a burn through hole but did not burn.

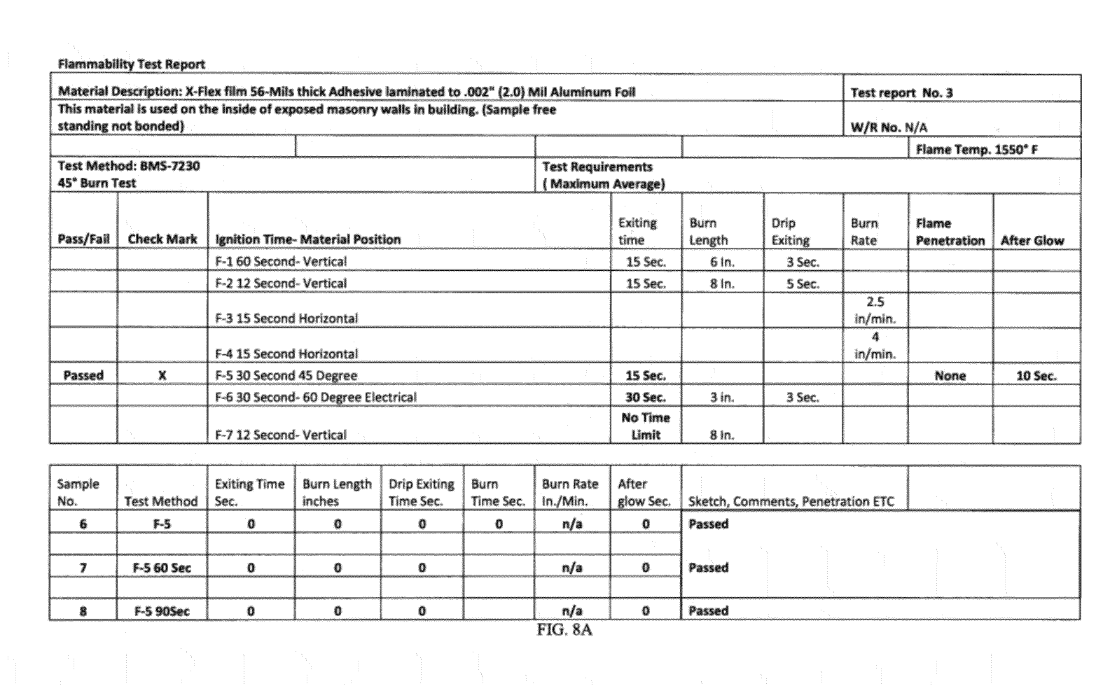

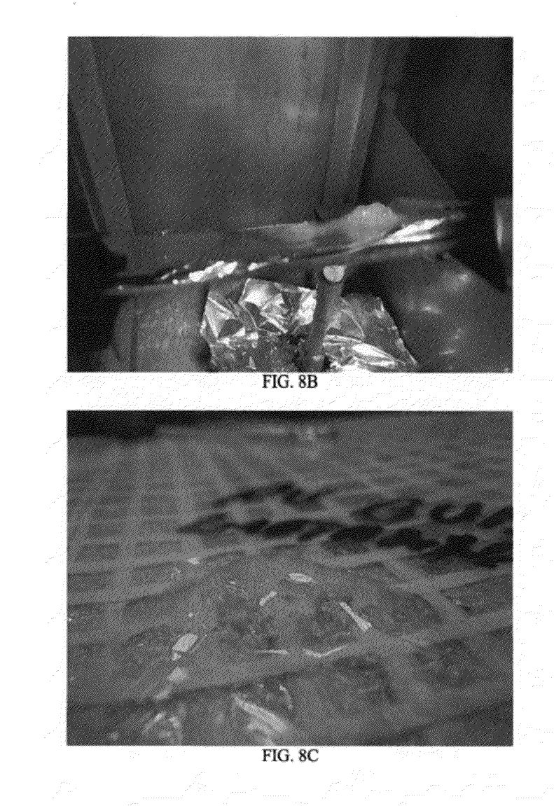

In Test No. 3 a 2 mil aluminum foil laminate was tested. The laminate was initially tested free standing and not bonded to anything just as the lighter gauge foils were tested. Samples number 6, 7, and 8 passed with flame contact times of 30 sec, 60 sec and 90 sec. The polyurethane melted and formed a bubble on the opposite side of the foil. The urethane did not flow or burn. See FIGS. 8A-C. FIG. 8A is a chart of flammability test labeled Report No. 3. FIG. 8B is a photograph of a passed 90 second flame contact time burn test showing the burn test in progress on 2 mil aluminum foil. FIG. 8C is a photograph of a passed 90 second flame contact time to the exposed side of the 2 mil foil side burn test showing the slight bubbling of the polyurethane but no burn through or melt.

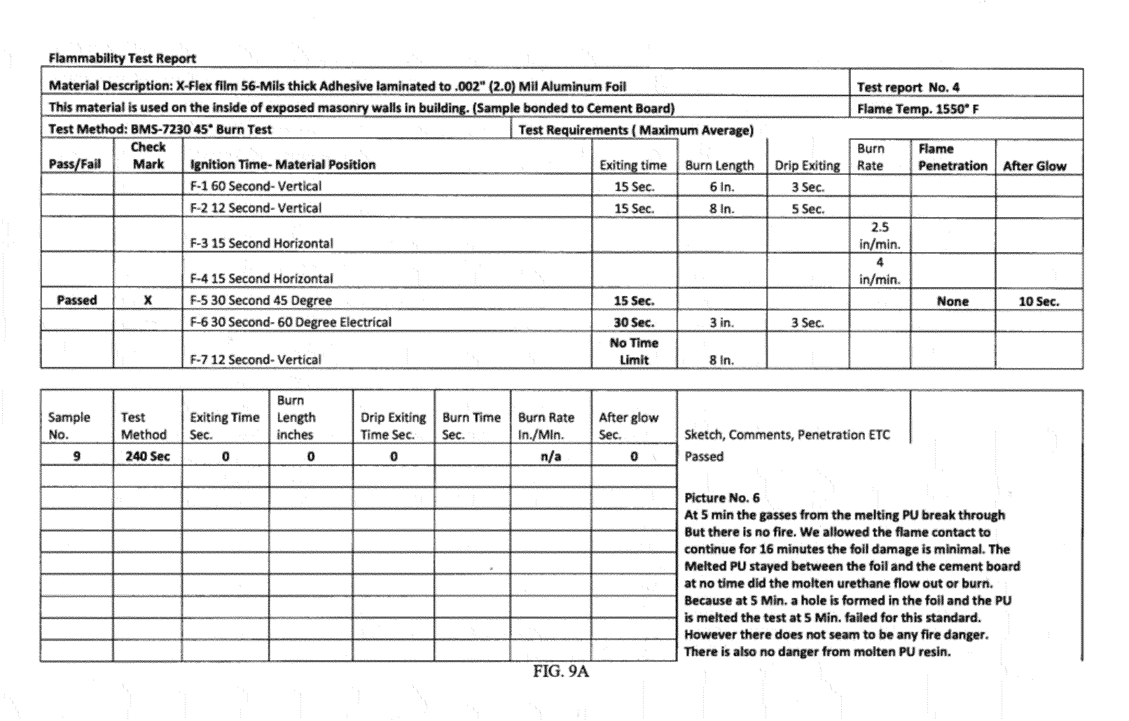

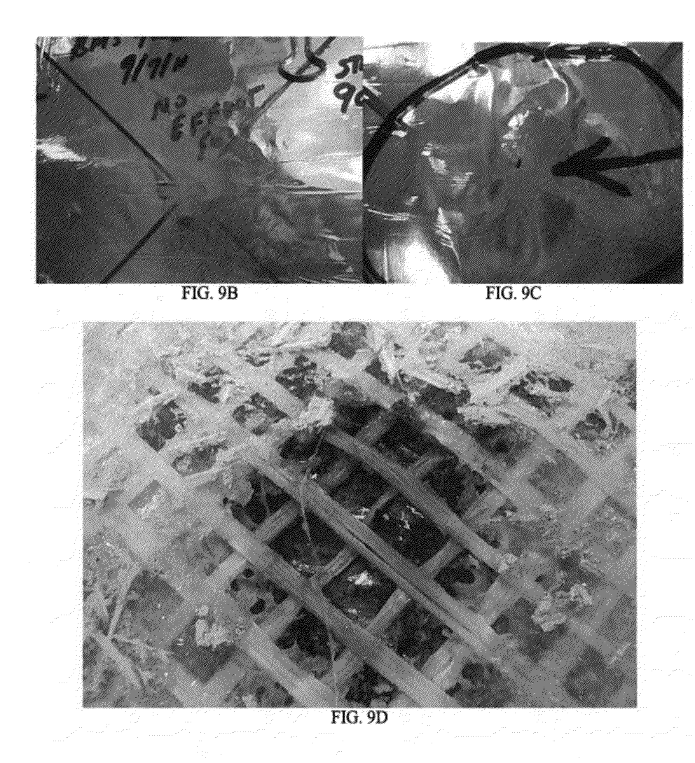

In Test No. 4 the 2 mil laminate was bonded to a cement panel and reapplied the flame to the foil surface of the laminate. The sample did not fail after a full five minutes of flame contact. During this time the urethane was melting behind the foil, it never burned into an open flame. The flame was allowed to remain in contact for 16 minutes, at the 5 minute mark a small hole was generated in the foil from the pressure of the polyurethane gas formulation, but at no point in the burn test was an open flame observed. Furthermore, there was no flow of the molten urethane out of the surface of the foil and it remained confined behind the foil web. See FIG. 9A-D. FIG. 9A is a chart of flammability test labeled Report No. 4. FIG. 9B is a photograph of a passed burn test and shows no damage to the 2 mil foil after 240 seconds of flame contact. This sample was adhesive bonded to a cement board panel. FIG. 9C is a photograph of a failed burn test and shows the damage after 16 minutes of flame contact. Note only slight damage to the foil side of the bonded panel. Although by the test coterie this is a failed test, the sample did not burn. FIG. 9D is a photograph of a failed burn test and shows the damage to the polyurethane and adhesive bonded to the cement panel the undamaged area of adhesive tore cement and fibers from the cement board when the sample was removed after 16 minutes of flame contact. There was no flow of burned or molten polyurethane the sample did not burn.

Based on these tests this construction was determined to be flame retardant. This foil approach does not add any hazard to the construction as it will not separate from its bond point. Since the foil's tensile modulus is negligible compared to the polyurethane film of the present disclosure and Kevlar™ composite, this is an inexpensive solution to the flame retardant problem and may simplify the manufacturing of the product and reduce scrap.

While the embodiments have been described in connection with specific embodiments, it is not intended that the scope be limited to the particular embodiments set forth, as the embodiments herein are intended in all respects to be illustrative rather than restrictive.

The headings used herein are for organizational purposes only and are not meant to be used to limit the scope of the description or the claims. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

As used in the specification and the appended claims, the singular forms “a,” “an” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this disclosure, the word “comprise” and variations of the word, such as “comprising” and “comprises,” means “including but not limited to,” and is not intended to exclude, for example, other additives, components, integers or steps. “Exemplary” means “an example of' and is not intended to convey an indication of a preferred or ideal embodiment. “Such as” is not used in a restrictive sense, but for explanatory purposes.

Disclosed are components that can be used to perform the disclosed methods, equipment and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

It should further be noted that any patents, applications and publications referred to herein are incorporated by reference in their entirety.

claimed is:

1. A reinforced flame retardant film material, comprising:
a) a first layer of an elastomeric polymer material;
b) a second layer of an elastomeric polymer material;
c) an adhesive layer comprising a pressure sensitive adhesive;
d) a layer of an energy absorptive or dissipative material;
e) a release liner associated with the adhesive layer; and,
f) a layer of a flame retardant material,
wherein the reinforced fire retardant film material is arranged in the order of the fire retardant layer, the first layer of elastomeric polymer material, the energy absorptive or dissipative layer, the second layer of elastomeric polymer material, and the adhesive layer, and,
wherein the reinforced fire retardant film material has a puncture resistance in a range between about 3,000 psi and about 25,000 psi.

2. The reinforced flame retardant film material of claim 1, wherein the flame retardant material is a metallic or metalized material.

3. The reinforced flame retardant film material of claim 2, wherein the flame retardant material is aluminum foil.

4. The reinforced film of claim 1, wherein the energy absorptive or dissipative material comprises at least one polyaramid.

5. The reinforced film of claim 1, wherein the elastomeric polymer material is selected from the group consisting of polyurethane, silicone, polyethylene, polypropylene, and rubber.

6. The reinforced flame retardant film material of claim 1, wherein the flame retardant layer has a thickness in a range of 0.285 to 10 mil and wherein the reinforced flame retardant film is flame retardant for at least 30 seconds to 5 minutes according to the BMS-7230—Method F5 45 degree burn test method (formerly known as ASTM F1103-93).

7. The reinforced flame retardant film material of claim 1, wherein the flame retardant layer has a thickness in a range of 1-2 mil and wherein the reinforced flame retardant film is flame retardant for at least 1 minute according to the BMS-7230—Method F5 45 degree burn test method (formerly known as ASTM F1103-93).

8. The reinforced flame retardant film material of claim 1, wherein the film has a puncture resistance of at least 5,000 psi and a percent elongation range of about 497% to about 551%.

9. The reinforced flame retardant film material of claim 1, wherein the flame retardant layer comprises a plurality of layers, at least one layer of which comprises a flame retardant material.

10. The reinforced flame retardant film material of claim 1, wherein the flame retardant layer is associated with the first layer by adhesion using a second adhesive material.

11. The reinforced flame retardant film material of claim 1, wherein the flame retardant layer is associated with the first layer by extrusion lamination.

12. The reinforced flame retardant film material of claim 1, wherein the flame retardant layer is electrically grounded.

13. The reinforced flame retardant film material of claim 1, wherein at least a portion of each of the first and second layers of elastomeric polymer material are bonded to each other through openings defined in the energy absorptive or dissipative layer such that when the film material is subjected to a blast force the film material will exhibit slippage between the first and second layers of elastomeric polymer material.

14. A flame retardant reinforcement film, comprising: a layer of a flame retardant material, a layer of a polymeric material, a layer of an energy absorptive or dissipative material, a layer of an adhesive material, and a removable release liner, wherein the film is arranged in the order of the flame retardant material layer, the energy absorptive or dissipative material layer, the polymeric material layer, the adhesive material layer, and the removable release liner, wherein the film wherein has a puncture resistance after the removable release liner is removed to expose the adhesive layer of between 3,000 psi and 25,000 psi as determined according to ASTM D-1000 (with a 0.166 inch needle), wherein the flame retardant layer material has a thickness in a range of 0.285 to 10 mil and the reinforced flame retardant film is flame retardant for at least 30 seconds to 5 minutes according to the BMS-7230—Method F5 45 degree burn test method (formerly known as ASTM F1103-93) and wherein the reinforced flame retardant film is configured to be rolls.

15. A multi-layer flame retardant film, comprising:
a) at least one layer of an energy absorptive or dissipative material having a first side and a second side and comprising a plurality of either fiber bundles, fiber strands or a mixture of fiber bundles and fiber strands, the fibers being between about 1,000 to about 10,000 denier, the fibrous energy absorptive or dissipative material having a plurality of openings between the fiber bundles or strands;
b) at least one layer of an elastomeric material associated with each side of the energy absorptive or dissipative layer material, each elastomeric material layer having a thickness of between about 2 mils and about 75 mils;
c) a layer of a pressure sensitive adhesive material; and
d) a layer of a flame retardant material,
wherein the multi-layer flame retardant film has a puncture resistance of between 3,000 psi and 25,000 psi as determined according to ASTM D-1000 (with a 0.166 inch needle), and is configured as a roll, and
wherein at least a portion of the elastomeric layer material on each side of and in contact with the energy absorptive or dissipative layer material are bonded to each other with the adhesive material through at least a portion of the openings in the fibrous energy absorptive or dissipative material.

16. The multi-layer flame retardant film of claim 16, wherein the energy absorptive or dissipative material comprises a plurality of fibers oriented in the warp direction.

17. The multi-layer flame retardant film of claim 16, wherein the energy absorptive or dissipative material comprises a plurality of layers of energy absorptive or dissipative material, wherein adjacent energy absorptive or dissipative layers are oriented either as overlapped, cross-directional or separated by the at least one layer of elastomeric material.

18. A structural wall or ceiling panel, comprising:
a) a wall or ceiling panel material; and,
b) a reinforced film associated with the wall or ceiling panel material, the reinforced film comprising,
(i) a first layer of an elastomeric polymer material,
(ii) a second layer of an elastomeric polymer material,
(iii) an adhesive layer comprising a pressure sensitive adhesive,
(iv) a layer of an energy absorptive or dissipative material, and
(v) a layer of a flame retardant material,
wherein the reinforced film is arranged in the order of the flame retardant layer, the first layer, the energy absorptive or dissipative layer, the second layer, and the adhesive layer,
wherein the reinforced film has a puncture resistance in a range between about 3,000 psi and about 25,000 psi, and,
wherein the flame retardant layer has a thickness in a range of 0.285 to 10 mil and the reinforced flame retardant film is flame retardant for at least 0 seconds to 5 minutes according to the BMS-7230—Method F5 45 degree burn test method (formerly known as ASTM F1103-93).

19. A reinforced flame retardant film material, comprising:
a) a first layer of an elastomeric polymer material;
b) a second layer of an elastomeric polymer material;
c) an adhesive layer comprising a pressure sensitive adhesive;
d) a release liner associated with the adhesive layer; and,
e) a layer of a flame retardant material,
wherein the reinforced fire retardant film material is arranged in the order of the fire retardant layer, the first layer of elastomeric polymer material, the second layer of elastomeric polymer material, and the adhesive layer, and,
wherein the reinforced fire retardant film material has a puncture resistance in a range between about 3,000 psi and about 25,000 psi.
